(19) United States
(12) Patent Application Publication
(10) Pub. No.: US 2024/0026185 A1
(43) Pub. Date: Jan. 25, 2024

(54) MODIFIED PARA-ARAMID POLYMER SOLUTION, COATING SLURRY, LITHIUM BATTERY SEPARATOR AND PREPARATION METHOD THEREOF

(71) Applicant: TAYHOADVANCED MATERIALS GROUP CO., LTD., Yantai (CN)

(72) Inventors: Qi CHEN, Yantai (CN); Haibing MA, Yantai (CN); Qianli MA, Yantai (CN)

(21) Appl. No.: 18/254,160

(22) PCT Filed: Aug. 13, 2021
(86) PCT No.: PCT/CN2021/112534

§ 371 Date: May 23, 2023

(30) Foreign Application Priority Data
Dec. 16, 2020 (CN) 202011500608.2

(51) Int. Cl. C09D 177/10; C08G 69/40; C08G 69/44; C09D 177/12; C09D 7/20; C09D 7/80; C09D 7/61; H01M 50/403; H01M 50/423; H01M 50/434; H01M 50/446; H01M 50/417; H01M 50/457

(52) U.S. Cl. CPC C09D 177/10; C08G 69/40; C08G 69/44; C09D 177/12; C09D 7/20; C09D 7/80; C09D 7/61; H01M 50/403; H01M 50/423; H01M 50/434; H01M 50/446; H01M 50/417; H01M 50/457

(57) ABSTRACT

A modified para-aramid polymer solution, a coating slurry, a battery separator and preparation methods thereof provided, which belong to the field of lithium battery material. A modified para-aramid polymer solution is prepared, which can be directly used for preparing a coating slurry and for coating a lithium battery separator. The problem that the traditional para-aramid is difficult to dissolve in polar solvents to prepare a coated film is effectively solved; and in the prepared lithium battery separator, ceramic particles are wrapped in the three-dimensional network structure of the modified para-aramid, so that the shortage of powder falling of ceramic particles is effectively improved, and the thermal performance and safe use performance of the lithium battery separator are improved. The present method has obvious advantages of high production efficiency, good product performance, low production cost and the like over the prior art.

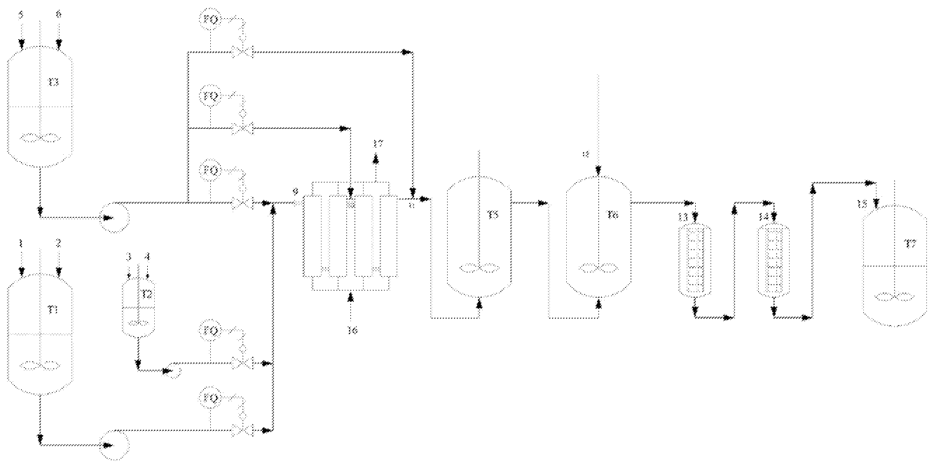

### TECHNICAL FIELD

The present application belongs to the field of polymer materials, and particularly relates to a modified para-aramid polymer solution, a coating slurry, a lithium battery separator and preparation methods thereof.

### BACKGROUND

At present, lithium battery separators are mostly made of polyolefin materials, e.g., polyethylene and polypropylene separators. However, such materials have poor heat resistance and wettability, and thus are usually coated on one or both sides of polyolefin separators. Commercially available are ceramic-coated films and PVDF-coated films. However, inorganic ceramics have poor adhesion to polyolefins and easily suffer from powder falling. Although PVDF improves the adhesion between separator and electrode, the high temperature resistance of the separator has not been greatly improved, which has impact on the safety of lithium batteries.

Para-aramid, i.e., poly (p-phenylene terephthalamide), which has the characteristics of intrinsic flame retardancy, high strength and high modulus, is widely used in bulletproof, personal protection and similar fields, and thus is a very important special high-performance polymer material. The application of para-aramid to membrane manufacturing fields such as water treatment membranes, lithium ion battery separators and like is one of application directions of para-aramid. The membrane made of para-aramid has the characteristics of both intrinsic flame retardancy and high strength, which makes it have a good application prospect in the fields of high-temperature filtration, fireproof coating and high-temperature lithium ion battery separators. However, it is extremely difficult for para-aramid to dissolve in polar solvents, which limits its processing and application in the field of membranes.

The inherent viscosity (Iv value) of the polymer solution required for the traditional manufacture of para-aramid fiber is greater than 5.0 dL/g, and the molecular weight is generally greater than 30,000. However, in view of the stability of the polymer solution and the processability of the membrane, the synthesis method thereof is slightly different from that of the polymer for fiber. Since the solubility of para-aramid fiber of a high molecular weight in traditional solvents is very small, and it is difficult to form a homogeneous solution with a high stability, it is difficult for para-aramid fiber to form a uniform membrane in the membrane-producing process. The problems of difficult processing and low preparation efficiency are particularly prominent especially in the application of a coated film. Therefore, it is particularly necessary to develop a lithium battery separator coated with modified para-aramid and a preparation method thereof, which is very important for developing high-temperature resistant, flame retardant and high-strength lithium battery membranes.

At present, the synthesis methods of para-aramid polymer for fiber usually include low-temperature solution polycondensation, interfacial polycondensation, direct polycondensation, etc. Among them, low-temperature solution polycondensation is applied in large-scale industrialization, and its polymerization equipment is usually a twin-screw extruder, which is suitable for the synthesis of high-viscosity polymers that have a large molecular weight and need to dissipate heat in time. In view of the characteristics of the relatively low molecular weight, solubility in traditional solvents and low viscosity of polymerization solution, the polymerization method of the para-aramid polymer for membranes, which is different from that of the para-aramid polymer for fibers, is more flexible in synthesis methods and processes.

Micro-reaction technology originated in Europe in the early 1990s, and its reactor channel size is micron-scale. Compared with traditional reactors, a micro-reactor has the advantages of short molecular diffusion distance, fast mass transfer, laminar flow in the channel, narrow residence time distribution, no backmixing, large specific surface area per unit volume, fast heat transfer speed, strong heat transfer ability and easy temperature control.

In the micro-channel reaction synthesis of meta-aramid and para-aramid, patents such as CN104667846A and CN110605079A have applied for micro-reaction systems for preparing meta-aramid and para-aramid resins, but so far there is no continuous synthesis method of a para-aramid coating slurry for a lithium battery separator.

Therefore, it is very important and desirable to use an efficient and convenient method to realize continuous and industrial synthesis of a para-aramid slurry for a membrane.

### SUMMARY

In view of the problems that the coated film of para-aramid is difficult to prepare and the production efficiency is low, the present application provides a modified para-aramid polymer solution, a coating slurry, a lithium battery separator and a preparation method thereof. The inherent viscosity (with an Iv value of 0.2-3) of the prepared para-aramid polymer solution is less than 15,000, with a good solution stability, and the inherent viscosity of the solution will not change within 3 months. In addition, the present application adopts a microchannel reactor to continuously synthesize a high-stability para-aramid coating slurry for a lithium battery separator, so as to solve the problems that para-aramid is difficult to dissolve in polar organic solvents, the processability is poor, and the preparation efficiency is low.

In order to achieve the above purpose, the present application adopts the following technical solution.

A modified para-aramid polymer solution is provided, which including following raw materials in percentage by mass: 4%-20% of a cosolvent, 70%-92% of an organic solvent, of p-phenylenediamine, 0.33%-2.4% of a monomer and 1.69%-8.53% of terephthaloyl chloride;
the cosolvent is calcium chloride or lithium chloride;
the organic solvent is any one of N,N-dimethylacetamide, N-methylpyrrolidone, N,N-dimethylformamide, N-methylformamide and N-ethylpyrrolidone;
the monomer is one or two of 4,4′-diaminodiphenyl ether, 3,4′-diaminodiphenyl ether and polyether glycol.

A method for preparing the modified para-aramid polymer solution is provided, which including the following:
(1) continuous preparation of an organic solution of the cosolvent: continuously mixing a solid cosolvent with the organic solvent under stirring to prepare an organic solution A, where a weight percentage of the cosolvent in the organic solution A is 4%-20%;
(2) continuous preparation of an organic solution of p-phenylenediamine: continuously mixing solid p-phenylenediamine with part of the organic solution A under stirring to prepare an organic solution B, where a weight percentage of the p-phenylenediamine in the organic solution B is 1.89%40.38%, and a temperature of the organic solution B is kept at 0-30° C. after preparation;
(3) continuous preparation of an organic solution of terephthaloyl chloride: continuously mixing molten terephthaloyl chloride with part of the organic solution A under stirring to prepare an organic solution C, where a weight percentage of the terephthaloyl chloride in the organic solution C is 5.07%-25.59%, and a temperature of the organic solution C is kept at 0-30° C. after preparation;
(4) continuous preparation of an organic solution of the monomer: continuously mixing the monomer with the remaining organic solution A under stirring to prepare an organic solution D, where a weight percentage of a monomer in the organic solution D is 0.99%-7.2%, and a temperature of the organic solution D is kept at 0-30° C. after preparation;
(5) pre-polycondensation of modified para-aramid: continuously feeding the prepared organic solution B and organic solution D via a first feed inlet of a microchannel reactor, at the same time feeding part of the prepared organic solution C into a microchannel reaction plate via the first feed inlet and a second feed inlet, with a reaction temperature of −15-0° C. for a reaction time of 10-100s, and obtaining a modified para-aramid prepolycondensate;
(6) polymerization: adding the remaining organic solution C into the modified para-aramid prepolycondensate via a third feed inlet, and stirring and polymerizing for 15-30 min at a temperature of −15-0° C.; where at least two microchannel reaction plates are arranged between the first feed inlet and the second feed inlet and between the second feed inlet and the third feed inlet, and a molar ratio of a feed quantity of terephthaloyl chloride of the first feed inlet, the second feed inlet and the third feed inlet is (0.07-0.13):(0.03-0.07):(0.8-0.9);
(7) neutralization: flowing out polymer solution by overflow after the polymerization, and adding an alkaline substance into the overflowed polymer solution to neutralize a by-product hydrogen chloride in the polymer solution, where a reaction temperature is 30-90° C.; and
(8) continuous filtering and defoaming: continuously filtering and defoaming the mixed solution obtained in step (7) to obtain the modified para-aramid polymer solution.

Further, a volume ratio of the organic solution A in step (2), step (3) and step (4) is 1:1:1.

Further, the alkaline substance used in step (7) is calcium hydroxide, and a mass ratio of calcium hydroxide to terephthaloyl chloride is (0.8-1.2): 1.

A coating slurry for a lithium battery separator is provided, which including the modified para-aramid polymer solution and ceramic particles, where a weight percentage of the modified para-aramid polymer solution and ceramic particles is (30%-90%):(10%-70%).

Further, the ceramic particles are one or more of alumina, zirconia, magnesia, aluminum hydroxide, magnesium hydroxide, silica and titania, with a particle size of 10-1000 nm.

A method for preparing the coating slurry for a lithium battery separator is provided, which including: adding the ceramic particles into the modified para-aramid polymer solution and stirring uniformly to obtain the coating slurry for a lithium battery separator.

A lithium battery separator is provided, which including a substrate separator and a coated film; the substrate separator is one of polyethylene, polypropylene, a composite of polyethylene and polypropylene, polyethylene terephthalate nonwoven fabric, and cellulose nonwoven fabric; the coated film is obtained by coating the coating slurry on the substrate separator and performing post-treatment; in the coated film, the modified para-aramid forms a three-dimensional network structure, and the ceramic particles are wrapped in the three-dimensional network structure.

A method for preparing the lithium battery separator is provided, which including the following: coating the coating slurry on one side or both sides of the substrate separator, then immersing in a coagulation bath of an organic solvent for 10-300 seconds, and drying at to obtain the lithium battery separator coated with the modified para-aramid, where the organic solvent in the coagulation bath is any one or more of N,N-dimethylacetamide, N-methylpyrrolidone, N,N-dimethylformamide, and dimethyl phthalate.

Further, the prepared the lithium battery separator coated with the modified para-aramid has a thermal shrinkage of ≤2.0% after being placed in an oven at 130° C. for 1 h; the modified para-aramid in the prepared lithium battery separator coated with the modified para-aramid has an inherent viscosity of 0.3-3.0 and a molecular weight of 300-15000 Da.

Compared with the prior art, the present application has the following beneficial technical effects.
(1) A modified para-aramid slurry continuously prepared by a microchannel reactor is invented, which can be directly used for coating lithium battery separators, thereby effectively solving the problem that traditional para-aramid is difficult to dissolve in polar solvents to prepare coated films. Compared with the traditionally prepared pure solid para-aramid resin or para-aramid, the para-aramid polymer solution for a membrane prepared by the present application has good stability without sedimentation or solidification, no viscosity change within 3 months, and can be directly used in the production of membrane products, thus improving the processability of para-aramid materials.
(2) In the modified para-aramid coating, the modified para-aramid forms a three-dimensional network structure, and the ceramic particles are wrapped in the three-dimensional network structure, which increases the adhesion between the ceramic particles and the separator, effectively avoids the phenomenon of “powder falling” and enhances the adhesion between the coating and the substrate separator.
(3) The heat resistance of the separator is improved. The heat resistance of the separator is greatly improved by adding a modified para-aramid coating, and the transverse thermal shrinkage at 130° C. for 1 hour is ≤2.0%.
(4) The efficiency of preparing the para-aramid coating solution is high. By adopting a microchannel reactor and a continuous preparation method, the operation is simple and convenient, which saves the complicated process of synthesizing para-aramid from a polymerization monomer and then dissolving para-aramid in concentrated sulfuric acid to prepare a polymer solution, thereby shortening the preparation process and reducing the cost.

### BRIEF DESCRIPTION OF DRAWINGS

FIGURE is a schematic diagram of a microchannel reactor used in the present application.

In the FIGURE: 1, First inlet; 2, Second inlet; 3, Third inlet; 4, Fourth inlet; 5, Fifth inlet; 6, Sixth inlet; 7, Seventh inlet; 10, Second feed inlet; 11, Third feed inlet; 12, Fourth feed inlet; 13, Filter inlet; 14, Defoaming inlet; 15, Liquid storage inlet; 16, Refrigerant inlet; 17, Refrigerant outlet; T1, T2 and T3, Blending tanks; T5, Polymerization kettle; T6, Neutralization tank; T7, Liquid storage tank.

### DESCRIPTION OF EMBODIMENTS

The present application will be described in further detail below:

A modified para-aramid polymer solution is provided, which including the following raw materials in percentage by mass: 4%-20% of a cosolvent, 70%-92% of an organic solvent, 0.63%-3.46% of p-phenylenediamine, 0.33%-2.4% of a monomer and 1.69%-8.53% of terephthaloyl chloride; the cosolvent is calcium chloride or lithium chloride; the organic solvent is any one of N,N-dimethylacetamide, N-methylpyrrolidone, N,N-dimethylformamide, N-methylformamide and N-ethylpyrrolidone; the monomer is one or two of 4,4′-diaminodiphenyl ether, 3,4′-diaminodiphenyl ether and polyether glycol.

A method for preparing the modified para-aramid polymer solution is provided, which including the following:
(1) continuous preparation of an organic solution of the cosolvent: continuously mixing a solid cosolvent with the organic solvent under stirring to prepare an organic solution A; the weight percentage of the cosolvent in the organic solution A is 4%-20%;
(2) continuous preparation of an organic solution of p-phenylenediamine: continuously mixing solid p-phenylenediamine with part of the organic solution A under stirring to prepare an organic solution B; the weight percentage of the p-phenylenediamine in the organic solution B is 1.89%-10.38%, and the temperature of the organic solution B is kept at 0-30° C. after preparation;
(3) continuous preparation of an organic solution of terephthaloyl chloride: continuously mixing molten terephthaloyl chloride with part of the organic solution A under stirring to prepare an organic solution C; the weight percentage of the terephthaloyl chloride in the organic solution C is 5.07%-25.59%, and the temperature of the organic solution C is kept at 0-30° C. after preparation;
(4) continuous preparation of an organic solution of the monomer: continuously mixing the monomer with the remaining organic solution A under stirring to prepare an organic solution D; the weight percentage of a monomer in the organic solution D is 0.99%-7.2%, and the temperature of the organic solution D is kept at 0-30° C. after preparation;
(5) pre-polycondensation of modified para-aramid: continuously feeding the prepared organic solution B and organic solution D via a first feed inlet of a microchannel reactor, at the same time feeding part of the prepared organic solution C into a microchannel reaction plate via the first feed inlet and a second feed inlet, with a reaction temperature of −15-0° C. for a reaction time of 10-100s, and obtaining a modified para-aramid prepolycondensate;
(6) polymerization: adding the remaining organic solution C into the modified para-aramid prepolycondensate via a third feed inlet, and stirring and polymerizing for 15-30 min at a temperature of −15-0° C.; where at least two microchannel reaction plates are arranged between the first feed inlet and the second feed inlet and between the second feed inlet and the third feed inlet; the molar ratio of a feed quantity of terephthaloyl chloride of the first feed inlet, the second feed inlet and the third feed inlet is (0.07-0.13):(0.03-0.07):(0.8-0.9), and the molar ratio of the total amount of terephthaloyl chloride to the sum of terephthalamide and monomer in step (3) is 1:(1-1.05);
(7) neutralization: flowing out polymer solution by overflow after the polymerization, and adding an alkaline substance into the overflowed polymer solution to neutralize a by-product hydrogen chloride in the polymer solution; the reaction temperature is 30-90° C., and the mass ratio of calcium hydroxide to terephthaloyl chloride for neutralization is (0.8-1.2): 1;
(8) continuous filtering and defoaming: continuously filtering and defoaming the mixed solution obtained in step (7) to obtain the modified para-aramid polymer solution.

A coating slurry for a lithium battery separator is provided, which including the modified para-aramid polymer solution and ceramic particles, where a weight percentage of the modified para-aramid polymer solution and ceramic particles is (30%-90%):(10%-70%); he ceramic particles are one or more of alumina, zirconia, magnesia, aluminum hydroxide, magnesium hydroxide, silica and titania, with a particle size of 10-1000 nm.

A method for preparing the coating slurry for a lithium battery separator is provided, which including: adding the ceramic particles into the modified para-aramid polymer solution and stirring uniformly to obtain the coating slurry for a lithium battery separator.

A lithium battery separator is provided, which including a substrate separator and a coated film; the substrate separator is one of polyethylene, polypropylene, a composite of polyethylene and polypropylene, polyethylene terephthalate nonwoven fabric, and cellulose nonwoven fabric; the coated film is obtained by coating the coating slurry on the substrate separator and performing post-treatment; in the coated film, the modified para-aramid forms a three-dimensional network structure, and the ceramic particles are wrapped in the three-dimensional network structure.

A method for preparing the lithium battery separator is provided, which including the following: coating the coating slurry on one side or both sides of the substrate separator, then immersing in a coagulation bath of an organic solvent for 10-300 seconds, and drying at 20-80° C. to obtain the lithium battery separator coated with the modified para-aramid; the organic solvent in the coagulation bath is any one or more of N,N-dimethylacetamide, N-methylpyrrolidone, N,N-dimethylformamide, and dimethyl phthalate.

The prepared the lithium battery separator coated with the modified para-aramid has a thermal shrinkage of ≤2.0% after being placed in an oven at 130° C. for 1 h; the modified para-aramid in the prepared lithium battery separator coated with the modified para-aramid has an inherent viscosity of 0.3-3.0 and a molecular weight of 300-15000 Da.

The present application will be explained in more detail with reference to examples. It should be understood that the implementation of the present application is not limited to the following examples, and any formal modifications and/or changes made to the present application shall fall within the scope of protection of the present application.

In the present application, unless otherwise specified, all equipment and raw materials can be commercially purchased or are those commonly used in the industry. Unless otherwise specified, the methods in the following examples are all conventional methods in the art.

### Example 1

Solid calcium chloride was dissolved in N,N-dimethylacetamide to prepare an organic solution of calcium chloride with a mass percentage of 4%;

P-phenylenediamine and the above organic solution of calcium chloride were continuously added into a blending tank T1 under stirring via the first inlet 1 and the second inlet 2, respectively, to prepare an organic solution of p-phenylenediamine with a weight percentage of 1.89%, and the temperature of the solution was kept at 0° C. after blending.

Terephthaloyl chloride and the above organic solution of calcium chloride were continuously added into a blending tank T3 via the fifth inlet 5 and the sixth inlet 6, respectively, to prepare an organic solution of terephthaloyl chloride with a weight percentage of 5.07%, and the temperature of the solution was kept at 0° C. after blending.

4,4′-diaminodiphenyl ether and the above organic solution of calcium chloride were continuously added into a blending tank T2 via the third inlet 3 and the fourth inlet 4, respectively, to prepare an organic solution of 4,4′-diaminodiphenyl ether with a weight percentage of 0.99%, and the temperature of the solution was kept at 0° C. after blending.

The prepared organic solution of p-phenylenediamine and the organic solution of 4,4′-diaminodiphenyl ether were respectively continuously added to the inlet of a first reaction plate of the microchannel reactor via the first feed inlet 9 by a delivery pump. At the same time, the prepared organic solution of terephthaloyl chloride was divided into three parts, which were continuously added via the first inlet 9, the second inlet 10 and the third inlet 11 according to a molar ratio of substances of 0.07:0.03:0.9 to be mixed and reacted. The reaction temperature was controlled at −15° C. by adjusting the flow rate of the refrigerant inlet 16. Reaction was carried out in the microchannel reactor for 10s, and then the reactants were introduced into a polymerization kettle T5. The molar ratio of added p-phenylenediamine and monomer to the total terephthaloyl chloride was 1:1. The polymerization solution entered a neutralization tank T6 from the polymerization kettle T5 in an overflow way, and then calcium hydroxide was continuously added into the neutralization tank T6 for reaction under stirring. The molar ratio of the added calcium hydroxide to terephthaloyl chloride was 0.8:1 to neutralize the by-product hydrogen chloride dissolved in the solution. After the reaction is completed, the mixture entered the filter and the defoamer via the defoaming inlet 14 to remove insoluble substances and bubbles therein. The filtered and defoamed polymer solution entered a liquid storage tank T7 via a liquid storage inlet 15, and the obtained solution was precisely a polymer synthetic solution containing 2% modified para-aramid. The polymer was tested to have a Ubbelohde viscosity of 500 mpa·s.

### Example 2

Solid calcium chloride was dissolved in N,N-dimethylacetamide to prepare an organic solution of calcium chloride with a mass percentage of 10%;

P-phenylenediamine and the above organic solution of calcium chloride were continuously added into a blending tank T1 under stirring via the first inlet 1 and the second inlet 2, respectively, to prepare an organic solution of p-phenylenediamine with a weight percentage of 7.5%, and the temperature of the solution was kept at 15° C. after blending.

Terephthaloyl chloride and the above organic solution of calcium chloride were continuously added into a blending tank T3 via the fifth inlet 5 and the sixth inlet 6, respectively, to prepare an organic solution of terephthaloyl chloride with a weight percentage of 15.2%, and the temperature of the solution was kept at 15° C. after blending.

4,4′-diaminodiphenyl ether and the above organic solution of calcium chloride were continuously added into a blending tank T2 via the third inlet 3 and the fourth inlet 4, respectively, to prepare an organic solution of 4,4′-diaminodiphenyl ether with a weight percentage of 2.5%, and the temperature of the solution was kept at 15° C. after blending.

The prepared organic solution of p-phenylenediamine and the organic solution of 4,4′-diaminodiphenyl ether were respectively continuously added to the inlet of a first reaction plate of the microchannel reactor via the first feed inlet 9 by a delivery pump. At the same time, the prepared organic solution of terephthaloyl chloride was divided into three parts, which were continuously added via the first inlet 9, the second inlet 10 and the third inlet 11 according to a molar ratio of substances of 0.1:0.05:0.8 to be mixed and reacted. The reaction temperature was controlled at −7° C. by adjusting the flow rate of the refrigerant inlet 16. Reaction was carried out in the microchannel reactor for 60s, and then the reactants were introduced into a polymerization kettle T5. The molar ratio of added p-phenylenediamine and monomer to the total terephthaloyl chloride was 1:1. The polymerization solution entered a neutralization tank T6 from the polymerization kettle T5 in an overflow way, and then calcium hydroxide was continuously added into the neutralization tank T6 for reaction under stirring. The molar ratio of the added calcium hydroxide to terephthaloyl chloride was 1:1 to neutralize the by-product hydrogen chloride dissolved in the solution. After the reaction is completed, the mixture entered the filter and the defoamer via the defoaming inlet 14 to remove insoluble substances and bubbles therein. The filtered and defoamed polymer solution entered a liquid storage tank T7 via a liquid storage inlet 15, and the obtained solution was precisely a polymer synthetic solution containing 6% modified para-aramid. The polymer was tested to have a Ubbelohde viscosity of 4000 mpa·s.

### Example 3

Solid calcium chloride was dissolved in N,N-dimethylacetamide to prepare an organic solution of calcium chloride with a mass percentage of 20%;

P-phenylenediamine and the above organic solution of calcium chloride were continuously added into a blending tank T1 under stirring via the first inlet 1 and the second inlet 2, respectively, to prepare an organic solution of p-phenylenediamine with a weight percentage of 10.38%, and the temperature of the solution was kept at 30° C. after blending.

Terephthaloyl chloride and the above organic solution of calcium chloride were continuously added into a blending tank T3 via the fifth inlet 5 and the sixth inlet 6, respectively, to prepare an organic solution of terephthaloyl chloride with a weight percentage of 25.59%, and the temperature of the solution was kept at 30° C. after blending.

4,4′-diaminodiphenyl ether and the above organic solution of calcium chloride were continuously added into a blending tank T2 via the third inlet 3 and the fourth inlet 4, respectively, to prepare an organic solution of 4,4′-diaminodiphenyl ether with a weight percentage of 7.2%, and the temperature of the solution was kept at 30° C. after blending.

The prepared organic solution of p-phenylenediamine and the organic solution of 4,4′-diaminodiphenyl ether were respectively continuously added to the inlet of a first reaction plate of the microchannel reactor via the first feed inlet 9 by a delivery pump. At the same time, the prepared organic solution of terephthaloyl chloride was divided into three parts, which were continuously added via the first inlet 9, the second inlet 10 and the third inlet 11 according to a molar ratio of substances of 0.13:0.07:0.8 to be mixed and reacted. The reaction temperature was controlled at 0° C. by adjusting the flow rate of the refrigerant inlet 16. Reaction was carried out in the microchannel reactor for 100s, and then the reactants were introduced into a polymerization kettle T5. The molar ratio of added p-phenylenediamine and monomer to the total terephthaloyl chloride was 1:1.05. The polymerization solution entered a neutralization tank T6 from the polymerization kettle T5 in an overflow way, and then calcium hydroxide was continuously added into the neutralization tank T6 for reaction under stirring. The molar ratio of the added calcium hydroxide to terephthaloyl chloride was 1.2:1 to neutralize the by-product hydrogen chloride dissolved in the solution. After the reaction is completed, the mixture entered the filter and the defoamer via the defoaming inlet 14 to remove insoluble substances and bubbles therein. The filtered and defoamed polymer solution entered a liquid storage tank T7 via a liquid storage inlet 15, and the obtained solution was precisely a polymer synthetic solution containing 10% modified para-aramid. The polymer was tested to have a Ubbelohde viscosity of 70000 mpa·s.

### Example 4

Solid calcium chloride was dissolved in N,N-dimethylacetamide to prepare an organic solution of calcium chloride with a mass percentage of 10%;

P-phenylenediamine and the above organic solution of calcium chloride were continuously added into a blending tank T1 under stirring via the first inlet 1 and the second inlet 2, respectively, to prepare an organic solution of p-phenylenediamine with a weight percentage of 4.93%, and the temperature of the solution was kept at 20° C. after blending.

Terephthaloyl chloride and the above organic solution of calcium chloride were continuously added into a blending tank T3 via the fifth inlet 5 and the sixth inlet 6, respectively, to prepare an organic solution of terephthaloyl chloride with a weight percentage of 12.8%, and the temperature of the solution was kept at 20° C. after blending.

4,4′-diaminodiphenyl ether and the above organic solution of calcium chloride were continuously added into a blending tank T2 via the third inlet 3 and the fourth inlet 4, respectively, to prepare an organic solution of 4,4′-diaminodiphenyl ether with a weight percentage of 2.89%, and the temperature of the solution was kept at 20° C. after blending.

The prepared organic solution of p-phenylenediamine and the organic solution of 4,4′-diaminodiphenyl ether were respectively continuously added to the inlet of a first reaction plate of the microchannel reactor via the first feed inlet 9 by a delivery pump. At the same time, the prepared organic solution of terephthaloyl chloride was divided into three parts, which were continuously added via the first inlet 9, the second inlet 10 and the third inlet 11 according to a molar ratio of substances of 0.09:0.04:0.85 to be mixed and reacted. The reaction temperature was controlled at −7° C. by adjusting the flow rate of the refrigerant inlet 16. Reaction was carried out in the microchannel reactor for 10s, and then the reactants were introduced into a polymerization kettle T5. The molar ratio of added p-phenylenediamine and monomer to the total terephthaloyl chloride was 1:1.05. The polymerization solution entered a neutralization tank T6 from the polymerization kettle T5 in an overflow way, and then calcium hydroxide was continuously added into the neutralization tank T6 for reaction under stirring. The molar ratio of the added calcium hydroxide to terephthaloyl chloride was 1:1 to neutralize the by-product hydrogen chloride dissolved in the solution. After the reaction is completed, the mixture entered the filter and the defoamer via the defoaming inlet 14 to remove insoluble substances and bubbles therein. The filtered and defoamed polymer solution entered a liquid storage tank T7 via a liquid storage inlet 15, and the obtained solution was precisely a polymer synthetic solution containing 5% modified para-aramid. The polymer was tested to have a Ubbelohde viscosity of 30000 mpa·s.

### Example 5

Solid calcium chloride was dissolved in N,N-dimethylacetamide to prepare an organic solution of calcium chloride with a mass percentage of 20%;

P-phenylenediamine and the above organic solution of calcium chloride were continuously added into a blending tank T1 under stirring via the first inlet 1 and the second inlet 2, respectively, to prepare an organic solution of p-phenylenediamine with a weight percentage of 6.57%, and the temperature of the solution was kept at 0° C. after blending.

Terephthaloyl chloride and the above organic solution of calcium chloride were continuously added into a blending tank T3 via the fifth inlet 5 and the sixth inlet 6, respectively, to prepare an organic solution of terephthaloyl chloride with a weight percentage of 12.44%, and the temperature of the solution was kept at 0° C. after blending.

4,4′-diaminodiphenyl ether and the above organic solution of calcium chloride were continuously added into a blending tank T2 via the third inlet 3 and the fourth inlet 4, respectively, to prepare an organic solution of 4,4′-diaminodiphenyl ether with a weight percentage of 3.8%, and the temperature of the solution was kept at 0° C. after blending.

The prepared organic solution of p-phenylenediamine and the organic solution of 4,4′-diaminodiphenyl ether were respectively continuously added to the inlet of a first reaction plate of the microchannel reactor via the first feed inlet 9 by a delivery pump. At the same time, the prepared organic solution of terephthaloyl chloride was divided into three parts, which were continuously added via the first inlet 9, the second inlet 10 and the third inlet 11 according to a molar ratio of substances of 0.1:0.06:0.85 to be mixed and reacted. The reaction temperature was controlled at −7° C. by adjusting the flow rate of the refrigerant inlet 16. Reaction was carried out in the microchannel reactor for 60s, and then the reactants were introduced into a polymerization kettle T5. The molar ratio of added p-phenylenediamine and monomer to the total terephthaloyl chloride was 1:1.02. The polymerization solution entered a neutralization tank T6 from the polymerization kettle T5 in an overflow way, and then calcium hydroxide was continuously added into the neutralization tank T6 for reaction under stirring. The molar ratio of the added calcium hydroxide to terephthaloyl chloride was 1.2:1 to neutralize the by-product hydrogen chloride dissolved in the solution. After the reaction is completed, the mixture entered the filter and the defoamer via the defoaming inlet 14 to remove insoluble substances and bubbles therein. The filtered and defoamed polymer solution entered a liquid storage tank T7 via a liquid storage inlet 15, and the obtained solution was precisely a polymer synthetic solution containing 5% modified para-aramid. The polymer was tested to have a Ubbelohde viscosity of 25000 mpa·s.

### Example 6

N-methylpyrrolidone in Example 2 was replaced by “N,N-dimethylformamide” and “4,4′-diaminodiphenyl ether” was replaced by “3,4′-diaminodiphenyl ether”. Other conditions such as preparation processes, process parameters and equipment types were the same as in Example 2.

### Example 7

N-methylpyrrolidone in Example 3 was replaced by “N-methylformamide” and “4,4′-diaminodiphenyl ether” was replaced by “3,4′-diaminodiphenyl ether”. Other conditions such as preparation processes, process parameters and equipment types were the same as in Example 3.

### Example 8

N-methylpyrrolidone in Example 4 was replaced by “N-ethylpyrrolidone” and “4,4′-diaminodiphenyl ether” was replaced by “polyether glycol”. Other conditions such as preparation processes, process parameters and equipment types were the same as in Example 4.

### Example 9

Ceramic particles were added into the liquid storage tank T7, and the modified para-aramid polymer solution obtained in Example 1 and alumina particles were evenly stirred according to a weight percentage of 30:70 to obtain a coating slurry.

### Example 10

Ceramic particles were added into the liquid storage tank T7, and the modified para-aramid polymer solution obtained in Example 2 and magnesium particles were evenly stirred according to a weight percentage of 60:40 to obtain a coating slurry.

### Example 11

Ceramic particles were added into the liquid storage tank T7, and the modified para-aramid polymer solution obtained in Example 3 and zirconia particles were evenly stirred according to the weight percentage of 90:10 to obtain a coating slurry.

### Example 12

Ceramic particles were added into the liquid storage tank T7, and the modified para-aramid polymer solution obtained in Example 4 and silicon dioxide particles were evenly stirred according to a weight percentage of 60:40 to obtain a coating slurry.

### Example 13

Ceramic particles were added into the liquid storage tank T7, and the modified para-aramid polymer solution obtained in Example 5 and titanium dioxide particles were evenly stirred according to a weight percentage of 90:10 to obtain a coating slurry.

### Example 14

Ceramic particles were added into the liquid storage tank T7, and the modified para-aramid polymer solution obtained in Example 6 and magnesium oxide particles were evenly stirred according to a weight percentage of 60:40 to obtain a coating slurry.

### Example 15

Ceramic particles were added into the liquid storage tank T7, and the modified para-aramid polymer solution obtained in Example 7 and zirconia particles were evenly stirred according to a weight percentage of 90:10 to obtain a coating slurry.

### Example 16

Ceramic particles were added into the liquid storage tank T7, and the modified para-aramid polymer solution obtained in Example 8 and silicon dioxide particles were evenly stirred according to a weight percentage of 60:40 to obtain a coating slurry.

### Example 17

The coating slurry obtained in Example 9 was coated on one side of a polyethylene substrate separator, which was then immersed in a coagulation bath of N-methylpyrrolidone for 10 seconds, followed by drying at 20° C., thereby obtaining a modified para-aramid coated lithium battery separator.

### Example 18

The coating slurry obtained in Example 10 was coated on both sides of polyethylene terephthalate nonwoven fabric, which was then immersed in a coagulation bath of N-methylpyrrolidone for 160 seconds, followed by drying at 52° C., thereby obtaining a modified para-aramid coated lithium battery separator.

### Example 19

The coating slurry obtained in Example 11 was coated on one side of a polypropylene substrate separator, which was then immersed in a coagulation bath of N,N-dimethylformamide for 300 seconds, followed by drying at 80° C., thereby obtaining a modified para-aramid coated lithium battery separator.

### Example 20

The coating slurry obtained in Example 12 was coated on one side of cellulose non-woven fabric, which was then immersed in a coagulation bath of dimethyl phthalate for 160 seconds, followed by drying at 52° C., thereby obtaining a modified para-aramid coated lithium battery separator.

### Example 21

The coating slurry obtained in Example 13 was coated on one side of a composite of polyethylene and polypropylene, which was then immersed in a coagulation bath of N,N-dimethylacetamide for 300 seconds, followed by drying at 80° C., thereby obtaining a modified para-aramid coated lithium battery separator.

### Example 22

The coating slurry obtained in Example 14 was coated on both sides of polyethylene terephthalate nonwoven fabric, which was then immersed in a coagulation bath of N-methylpyrrolidone for 160 seconds, followed by drying at 52° C., thereby obtaining a modified para-aramid coated lithium battery separator.

### Example 23

The coating slurry obtained in Example 15 was coated on one side of a polypropylene substrate separator, which was then immersed in a coagulation bath of N,N-dimethylformamide for 300 seconds, followed by drying at 80° C., thereby obtaining a modified para-aramid coated lithium battery separator.

### Example 24

The coating slurry obtained in Example 16 was coated on one side of cellulose non-woven fabric, which was then immersed in the coagulation bath of dimethyl phthalate for 160 seconds, followed by drying at 52° C., thereby obtaining a modified para-aramid coated lithium battery separator.

### Comparative Example 1

The substrate separator was immersed in a coagulation bath of N,N-dimethylacetamide, with other conditions being the same as those in Example 1, to prepare a separator.

### Comparative Example 2

The substrate separator was coated with ceramics and then immersed in the coagulation bath of N,N-dimethylacetamide, with other conditions being the same as those in Example 1, to prepare a separator.

### Comparative Example 3

A traditional twin-screw was used polymerization reaction, with other conditions being the same as those in Example 1, to prepare an aramid coated film.

### Comparative Example 4

An aramid coated film was prepared without addition of 4,4′-diaminodiphenyl ether, with other conditions being the same as those in Example 1.

### Comparative Example 5

A traditional twin screw was used for polymerization reaction, with other conditions being the same as those in Example 5, to prepare an aramid coated film.

Indices of Polymerization Solution

The polymer solutions and membranes obtained in the above examples and comparative examples 1-8 were tested for performance, and the test results were as follows:

| | | | | | | Longitudinal | |
|---|---|---|---|---|---|---|---|
| | | | | | | thermal | |
| | Rotational | | | | | shrinkage of | Peel |
| | viscosity | Iv | Polymer | | | the membrane | strength |
| Examples | (mPas) | value | content | Stability | Examples | (130° C., 1 h) | (N/m) |
| Example 1 | 520 | 0.3 | 2% | No phase | Example 17 | 2.5% | 126 |
| | | | | splitting | | | |
| Example 2 | 40520 | 2.1 | 6% | No phase | Example 18 | 1.5% | 138 |
| | | | | splitting | | | |
| Example 3 | 71040 | 3.0 | 10% | No phase | Example 19 | 1.0% | 152 |
| | | | | splitting | | | |
| Example 4 | 32425 | 1.8 | 5% | No phase | Example 20 | 1.5% | 154 |
| | | | | splitting | | | |
| Example 5 | 25835 | 1.6 | 5% | No phase | Example 21 | 2.0% | 145 |
| | | | | splitting | | | |
| Example 6 | 39076 | 2.0 | 6% | No phase | Example 22 | 1.6% | 140 |
| | | | | splitting | | | |
| Example 7 | 68545 | 2.7 | 10% | No phase | Example 23 | 1.2% | 150 |
| | | | | splitting | | | |
| Example 8 | 27500 | 1.9 | 5% | No phase | Example 24 | 1.7% | 148 |
| | | | | splitting | | | |
| Comparative | — | — | — | — | Comparative | Shrink, | — |
| example 1 | | | | | example 1 | become | |
| | | | | | | transparent | |
| Comparative | — | — | — | — | Comparative | 2.0% | 15 |
| example 2 | | | | | example 2 | | |
| Comparative | 1000 | 0.5 | 2% | Phase | Comparative | 3.8% | 22 |
| example 3 | | | | splitting | example 3 | | |
| Comparative | 2000 | 1.1 | 2% | Phase | Comparative | 4.0% | 25 |
| example 4 | | | | splitting | example 4 | | |
| Comparative | 32400 | 1.8 | 10% | Phase | Comparative | 2.5% | 28 |
| example 5 | | | | splitting | example 5 | | |

As can be seen from the above table, the stability and membrane thermal shrinkage index of the polymer solution prepared by the present application are obviously better than those of the substrate separator, and the ceramic particles can be bonded without adding an adhesive.

The above examples are only preferred examples of the present application, and are not intended to limit the present application. For those skilled in the art, various modifications and variations may be made to the present application. Any modification, equivalent substitution, improvement and the like made within the spirit and principle of the present application shall be included in the protection scope of the present application.

1. (canceled)

2. A method for preparing a modified para-aramid polymer solution, wherein the modified para-aramid polymer solution comprises the following raw materials in percentage by mass: 4%-20% of a cosolvent, 70%-92% of an organic solvent, 0.63%-3.46% of p-phenylenediamine, 0.33%-2.4% of a monomer, and 1.69%-8.53% of terephthaloyl chloride;
wherein the cosolvent is calcium chloride or lithium chloride;
the organic solvent is any one of N,N-dimethylacetamide, N-methylpyrrolidone, N,N-dimethylformamide, N-methylformamide and N-ethylpyrrolidone;
the monomer is one or two of 4,4′-diaminodiphenyl ether, 3,4′-diaminodiphenyl ether and polyether glycol,
wherein the method comprises the following:
(1) continuous preparation of an organic solution of the cosolvent: continuously mixing a solid cosolvent with the organic solvent under stirring to prepare an organic solution A, wherein a weight percentage of the cosolvent in the organic solution A is 4%-20%;
(2) continuous preparation of an organic solution of p-phenylenediamine: continuously mixing solid p-phenylenediamine with part of the organic solution A under stirring to prepare an organic solution B, wherein a weight percentage of the p-phenylenediamine in the organic solution B is 1.89%-10.38%, and keeping a temperature of the organic solution B at 0-30° C. after preparation;
(3) continuous preparation of an organic solution of terephthaloyl chloride: continuously mixing molten terephthaloyl chloride with part of the organic solution A under stirring to prepare an organic solution C, wherein a weight percentage of the terephthaloyl chloride in the organic solution C is 5.07%-25.59%, and keeping a temperature of the organic solution C at 0-30° C. after preparation;
(4) continuous preparation of an organic solution of the monomer: continuously mixing the monomer with the remaining organic solution A under stirring to prepare an organic solution D, wherein a weight percentage of a monomer in the organic solution D is 0.99%-7.2%, and keeping a temperature of the organic solution D at 0-30° C. after preparation;
(5) pre-polycondensation of modified para-aramid: continuously feeding the prepared organic solution B and organic solution D via a first feed inlet of a microchannel reactor, at the same time feeding part of the prepared organic solution C into a microchannel reaction plate via the first feed inlet and a second feed inlet, with a reaction temperature of −15-0° C. for a reaction time of 10-100s, to obtain a modified para-aramid prepolycondensate;
(6) polymerization: adding the remaining organic solution C into the modified para-aramid prepolycondensate via a third feed inlet, and stirring and polymerizing for 15-30 min at a temperature of −15-0° C.; wherein at least two microchannel reaction plates are arranged between the first feed inlet and the second feed inlet and between the second feed inlet and the third feed inlet, and a molar ratio of a feed quantity of terephthaloyl chloride of the first feed inlet, the second feed inlet and the third feed inlet is (0.07-0.13):(0.03-0.07):(0.8-0.9);
(7) neutralization: flowing out polymer solution by overflow after the polymerization, and adding an alkaline substance into the overflowed polymer solution to neutralize a by-product hydrogen chloride in the polymer solution, wherein a reaction temperature is 30-90° C.; and
(8) continuous filtering and defoaming: continuously filtering and defoaming the mixed solution obtained in step (7) to obtain the modified para-aramid polymer solution.

3. The method for preparing a modified para-aramid polymer solution of claim 2, wherein a volume ratio of the organic solution A in step (2), step (3) and step (4) is 1:1:1.

4. The method for preparing a modified para-aramid polymer solution of claim 2, wherein the alkaline substance used in step (7) is calcium hydroxide, and a mass ratio of calcium hydroxide to terephthaloyl chloride is (0.8-1.2): 1.

5-6. (canceled)

7. A method for preparing a coating slurry for lithium battery separator, comprising adding the ceramic particles into the modified para-aramid polymer solution prepared by the method of claim 2 and stirring uniformly to obtain the coating slurry for a lithium battery separator, wherein a weight percentage of the modified para-aramid polymer solution and the ceramic particles is (30%-90%):(10%-70%).

8. (canceled)

9. A method for preparing a lithium battery separator, comprising the following: coating the coating slurry prepared by the method of claim 7 on one side or both sides of the substrate separator, immersing in a coagulation bath of an organic solvent for 10-300 seconds, and drying at 20-80° C. to obtain the lithium battery separator coated with the modified para-aramid, wherein the organic solvent in the coagulation bath is any one or more of N,N-dimethylacetamide, N-methylpyrrolidone, N,N-dimethylformamide, and dimethyl phthalate, wherein the substrate separator is one of polyethylene, polypropylene, a composite of polyethylene and polypropylene, polyethylene terephthalate nonwoven fabric, and cellulose nonwoven fabric.

10. The method for preparing a lithium battery separator of claim 9, wherein the prepared the lithium battery separator coated with the modified para-aramid has a thermal shrinkage of ≤2.0% after being placed in an oven at 130° C. for 1 h; and the modified para-aramid in the prepared lithium battery separator coated with the modified para-aramid has an inherent viscosity of 0.3-3.0 and a molecular weight of 300-15000 Da.

11. The method for preparing a coating slurry for lithium battery separator of claim 7, wherein the ceramic particles are one or more of alumina, zirconia, magnesia, aluminum hydroxide, magnesium hydroxide, silica and titania, with a particle size of 10-1000 nm.
